(19) United States
(12) Patent Application Publication
(10) Pub. No.: US 2009/0201685 A1
(43) Pub. Date: Aug. 13, 2009

(54) METHODS AND SYSTEMS OF ATTACHING A DECORATIVE LIGHT MOUNTING DEVICE

(76) Inventor: Michael Brent George, Slaton, TX (US)

Correspondence Address: CONLEY ROSE, P.C.;David A. Rose, P. O. BOX 3267, HOUSTON, TX, 77253-3267, US

(21) Appl. No.: 12/424,895

(22) Filed: Apr. 16, 2009

Related U.S. Application Data
(63) Continuation-in-part of application No. 11/772,629, filed on Jul. 2, 2007.

(51) Int. Cl. F21V 21/096

(52) U.S. Cl. 362/398

(57) ABSTRACT

A method and system of attaching a decorative light mounting structure. At least some of the illustrative embodiments are methods comprising magnetically affixing a lower support of a light mounting structure to an upper surface of a metallic roofing material by encompassing in an aperture a head of a fastener previously coupled to the metallic roofing material, and coupling a bulb through a bulb aperture of a bulb support portion.

### CROSS-REFERENCE TO RELATED APPLICATIONS

This specification is a continuation-in-part of application Ser. No. 11/772,629, filed Jul. 2, 2007, titled “Method and Systems of Attaching a Decorative Light Mounting Device”, now ***, which application is incorporated by reference herein as if reproduced in full below.

### BACKGROUND

Several types of devices exist to assist home owners and business owners in attaching decorative lights to the exterior of their buildings, typically seasonally, such as during the Christmas holidays. Some of these devices assist the home owner or business owner in attaching the decorative lighting to hang from rain gutters. Other devices may attach by sliding between the roofing material (e.g., composition shingles) and the roof decking material. Others of these devices attach by clamping to the roofing material.

However, a growing trend in the construction industry is the use of sheet metal roofing material instead of composition shingles. In most cases, the sheet metal roofing material extends beyond the fascia material by several inches, thus making the support brackets configured to slide between the roofing material and the roof decking material unusable. In other cases, the sheet metal extends a very short distance beyond the fascia material, thus making a clamp-type device unusable.

### BRIEF DESCRIPTION OF THE DRAWINGS

For a more detailed description of various embodiments, reference will now be made to the accompanying drawings, wherein:

FIG. 1 shows decorative light mounting structures in accordance with at least some of the embodiments;

FIG. 2 shows a decorative light mounting structure in accordance with at least some of the embodiments;

FIG. 3 shows a partial cross-sectional view of a decorative light mounting structure in accordance with at least some of the embodiments;

FIG. 4 shows a decorative light mounting structure in accordance with at least some of the embodiments;

FIG. 5 shows a decorative light mounting structure in accordance with at least some of the embodiments;

FIG. 6 shows decorative light mounting structures with suspended-type decorative lights in accordance with at least some of the embodiments;

FIGS. 7A-7B show a decorative light mounting structure in accordance with at least some of the embodiments;

FIG. 8A shows a decorative light mounting structure in accordance with at least some of the embodiments;

FIGS. 8B shows partial cross-sectional view of a decorative light mounting structure in accordance with at least some of the embodiments;

FIGS. 9A-9B show a decorative light mounting structure in accordance with at least some of the embodiments;

FIGS. 10A-10B show a decorative light mounting structure in accordance with at least some of the embodiments;

FIG. 11 shows a cross-sectional view of the decorative light mounting structure in accordance with at least some of the embodiments; and

FIG. 12 shows a method in accordance with at least some of the embodiments.

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

FIG. 1 shows a decorative light mounting system 100 in accordance with at least some of the embodiments. In particular, each decorative bulb 104 is held in place on a sheet metal roof 102 by way of a decorative light mounting structure 108. The decorative light mounting structure 108 holds the bulb 104 in a consistent orientation across the installation, and also enables the consistent spacing of the bulbs 104 for an aesthetically pleasing configuration.

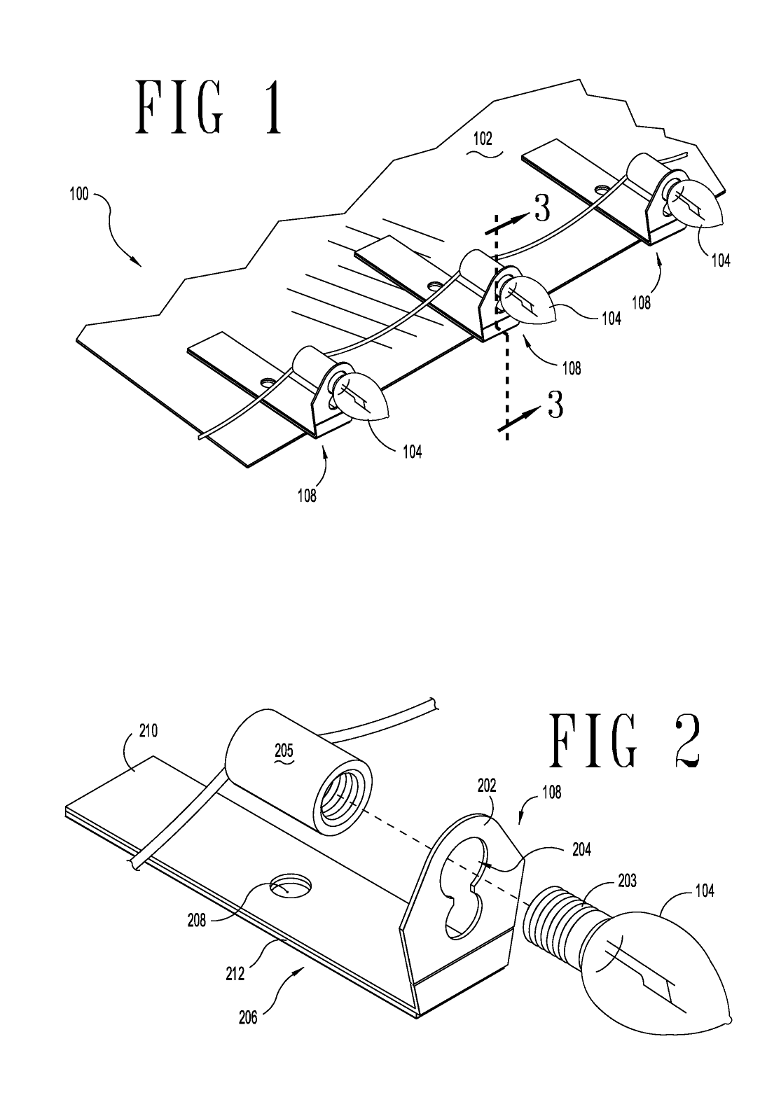

FIG. 2 shows in greater detail the decorative light mounting structure 108 in accordance with at least some of the embodiments. In particular, the decorative light mounting structure 108 comprises a bulb support portion 202 and an affixation portion 206 coupled to the bulb support portion 202. The bulb support portion 202 comprises a bulb aperture 204, and the bulb base 203 extends through the bulb aperture 204 and threadingly couples to the bulb socket 205. The bulb aperture 204 may be configured to have two or more different diameters such that bulb 104 and socket 205 assemblies of different sizes may be used with the decorative light mounting structure 108. In some embodiments, the bulb support portion 202 is made from materials such as metal, polypropylene, and polystyrene.

In at least some of the embodiments, the affixation portion 206 defines a plane that is substantially perpendicular to the plane defined by the bulb support portion 202. The affixation portion 206 has a thickness, when measured perpendicular to the plane defined by the affixation portion, of about 0.125 inches. In some embodiments, the affixation portion 206 comprises a coupling layer 210 and a magnetic strip 212 coupled to the coupling layer 210 by way of an adhesive. The coupling layer 210 may be made from materials such as metal, polypropylene, and polystyrene. The magnetic strip 212 is configured to at least partially affix the decorative light mounting structure 108 to the sheet metal roof 102. The magnetic strip 212 may be magnetic strip material available from Flexmag Industries of Marietta Ohio. In alternative embodiments, the magnetic strip 212 has a smaller area than the affixation portion 206. In at least some of the embodiments, the length of the affixation portion 206, as measured from the plane defined by the bulb support portion 202, is about 2 inches to about 5 inches; however, longer or shorter affixation portions 206 may be equivalently used.

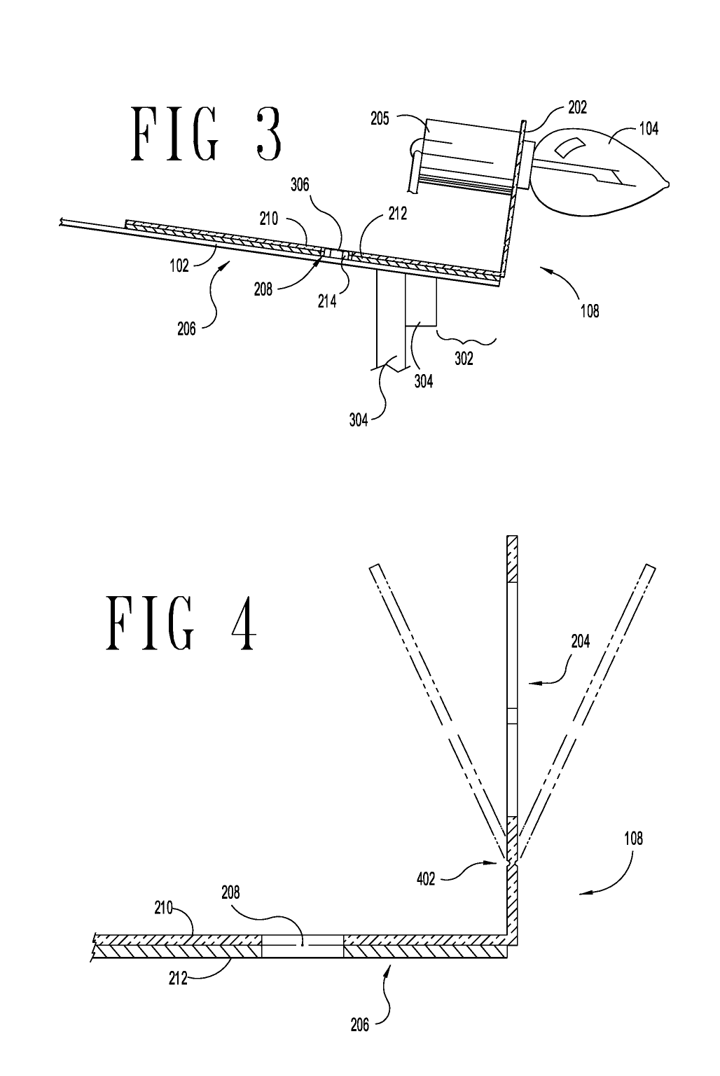

FIG. 3 shows a partial cross-sectional view taken along 3-3 of FIG. 1 in accordance with at least some of the embodiments. In particular, FIG. 3 illustrates the decorative light mounting structure 108 coupled to a metal roof 102 (e.g., by at least the magnetic strip 212). In the particular embodiments of FIG. 3, the metal roof 102 overhangs 302 the fascia material 304. The bulb 104 coupled to the socket 205 through the upper portion of the bulb aperture 204. The magnetic strip 212 is affixed to the sheet metal roof 102, thus ensuring affixation of the decorative light mounting structure 108 to the sheet metal roof 102. In some embodiments, a fastener aperture 208 is utilized to further secure the decorative light mounting structure 108 to the sheet metal roof 102, and to reduce motion of the decorative light mounting structure 108 in the plane defined by the affixation portion 206. In some embodiments, the fastener aperture 208 has an inside dimension of at least 0.5 inches. For example, consider the situation where a fastener (e.g., a screw or a nail) that was coupled to sheet metal roof 102 prior to affixation of the decorative light mounting structure 108 is located where a user desires to place a decorative light mounting structure 108. In the particular situation, the decorative light mounting structure 208 is placed such that the fastener aperture 208 substantially encompasses a head of the fastener 306 (e.g., a screw head) to prevent motion of the decorative light mounting structure 108 in the plane defined by the affixation portion 206. In the illustrative embodiments of FIG. 3, the decorative light mounting structure 108 “straddles” the head of the fastener 306 previously coupled to the sheet metal roof 102 by way of the fastener aperture 208. Stated otherwise, the head of the fastener 306 contacts only the inside surface 214 of the fastener aperture 208, and the fastener does not apply any force in direction perpendicular to the plane defined by the affixation portion 206 to affix the decorative light mounting structure 108 to the sheet metal roof 102. In the particular embodiment, the fastener aperture 208 has a circular shape. In other embodiments, the fastener aperture 208 may be any combination of any shape, such as a rectangle, an oval, or a triangle.

FIG. 4 shows a cross-sectional view of the decorative light mounting structure 108 in accordance with at least some embodiments. In some embodiments, a flexible pivot joint 402 may be located in the lower bulb support portion 202. The flexible pivot joint 402 enables the bulb support portion 202 to flex so as to reduce the possibility of the disconnection of the decorative light mounting structure 108 during high winds. In particular, by flexing (either toward or away the affixation portion 206) the bulb support portion 202 reduces the surface area against which wind may push. Higher winds may result in more flexing at the pivot joint 402, while low winds result in less flexing at the pivot joint 402. The lowered surface area thus lowers the torque applied by the wind to the overall decorative light mounting structure, lowering the possibility of the decorative light mounting structure 108 becoming dislodged by high wind.

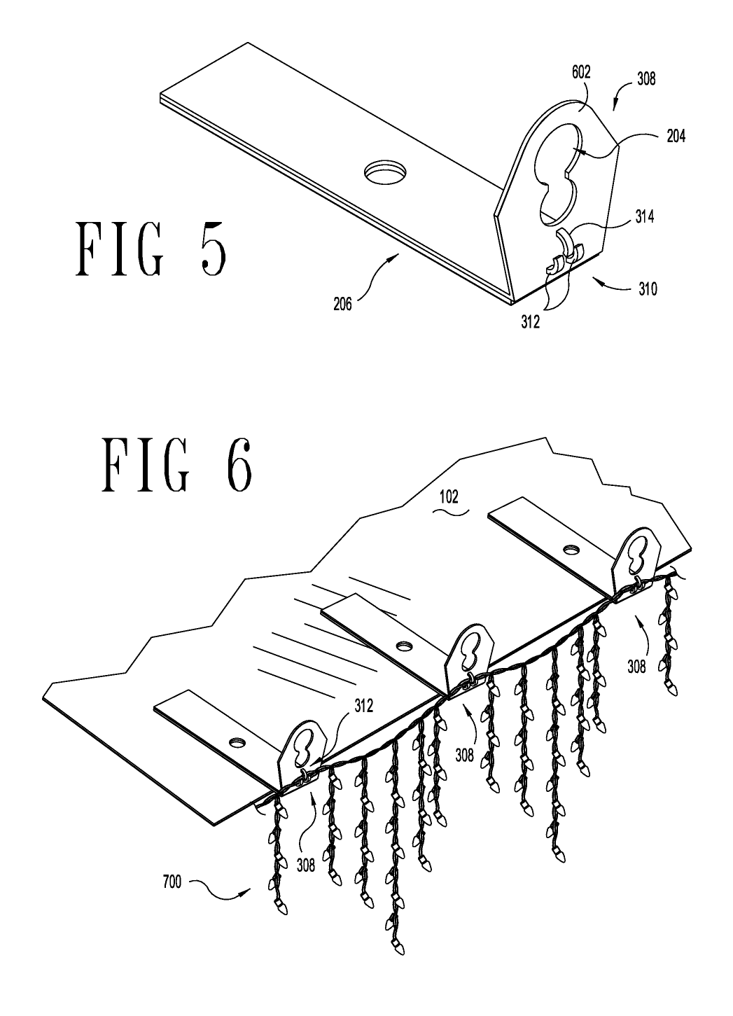

FIG. 5 shows a decorative light mounting structure 308 in accordance with alternative embodiments. In particular, FIG. 5 illustrates that the decorative light mounting structure 308 comprises a bulb support portion 602 and an affixation portion 206. The bulb support portion 602 is similar to the bulb support portion 202 in that the bulb support portion 602 comprises a bulb aperture 204, but differs in that the bulb support portion 602 also comprises fingers 310. In some embodiments, the fingers 310 comprise two upward pointing fingers 312, and one downward pointing finger 314. However, fewer fingers 312, and fingers pointing in alternative directions, may be equivalently used. The fingers 312 enable the decorative light mounting structure 308 to accommodate wiring for suspended-type decorative lights, such as lights that mimic the appearance of icicles.

FIG. 6 shows a plurality of the decorative light mounting structures 308 coupled to a roof material 102. A strand of decorative lights 700 is suspended from the roof material 102 by way of the decorative light mounting structures 308. In particular, at least a portion of the wires for the decorative lights 700 are engaged with the fingers 312 such that the decorative lights 700 are suspended. Thus, the decorative light mounting structures 308 not only support a bulb installed through the bulb apertures 204 (not shown in FIG. 6), but also enable the home owner or business owner to install suspended-type decorative lights 700.

FIG. 7A shows a top view of yet still other embodiment of a decorative light mounting structure 808. In particular, FIG. 7A illustrates that the decorative light mounting structure 808 comprises a bulb support portion 202 and an affixation portion 806. The affixation portion 806 is similar to affixation portion 206 of the embodiments of FIG. 2 in that the affixation portion 806 defines a plane that is substantially perpendicular to the plane defined by the bulb support portion 206, but differs in that the affixation portion 806 comprises two elongated fastener apertures 810 and 812. The elongated fastener aperture 810 defines a major axis 814 that is substantially perpendicular to a major axis 816 defined by the elongated fastener aperture 812. In some embodiments, inside dimensions of the elongated fastener aperture 810 and 812, when measured perpendicular to the major axis 814 and 816, are the same and are at least 0.5 inches. In other embodiments, the inside dimensions of the elongated fastener aperture 810 and 812 are different. Although, FIG. 7A shows only two elongated fastener apertures 810 and 812, the affixation portion 806 may comprise any number of elongated fastener apertures.

In at least some embodiments, the decorative light mounting structure 808 may utilize the elongated fastener apertures 810 and 812 to substantially encompass a head of a fastener (e.g., a screw head), the fastener previously coupled to metallic roofing material, to prevent motion of the decorative light mounting structure 808 in the direction perpendicular to the major axis 814 and 816. In some embodiment, the elongated apertures 810 and 812 allow motion of the decorative light structure 808 along the major axis 814 and 816. In particular, the decorative light mounting structure 808 is configured to “straddle” the head of the fastener previously coupled to the metallic roofing material located along either the major axis 814 of the elongated fastener aperture 810 or the major axis 816 of the elongated fastener aperture 812. Stated otherwise, the head of the fastener contacts only the inside surface of the elongated fastener aperture 810 and 812, and the fastener does not apply any force (i.e., in the direction perpendicular to the plane defined by the affixation portion 806) to affix the decorative light mounting structure 808 to the metallic roofing material. In some embodiments, the elongated fastener apertures 810 and 812 “straddle” and encompass heads of one or more fasteners previously coupled to metallic roofing material.

FIG. 7B shows a top view of an alternative embodiment of a decorative light mounting structure 908. In particular, FIG. 7B illustrates that the decorative light mounting structure 908 comprises a bulb support portion 202 and an affixation portion 906. The affixation portion 906 is similar to affixation portion 806 of the embodiments of FIG. 7A in that the affixation portion 906 comprises elongated fastener apertures 810, but differs in that the elongated fastener apertures 810 of the affixation portion 906 are substantially similar. The elongated fastener apertures 810 define the same major axis 814, and the elongated fastener apertures 810 have inside dimensions, when measured perpendicular to the major axis 814, of at least 0.5 inches. Although, FIG. 7B shows only two elongated fastener apertures 810, any number of elongated fastener apertures 810 may be equivalently used. Similar to the embodiments of FIG. 7A, the decorative light mounting structure 908 may utilize the elongated fastener apertures 810 to encompass a head of a fastener (e.g., a screw head), the fastener previously coupled to metallic roofing material, and located along the major axis 814 of the elongated fastener apertures 810 to prevent motion of the decorative light mounting structure 908 in the direction perpendicular to the major axis 814. In some embodiment, the elongated apertures 810 allow motion of the decorative light structure 808 along the major axis 814.

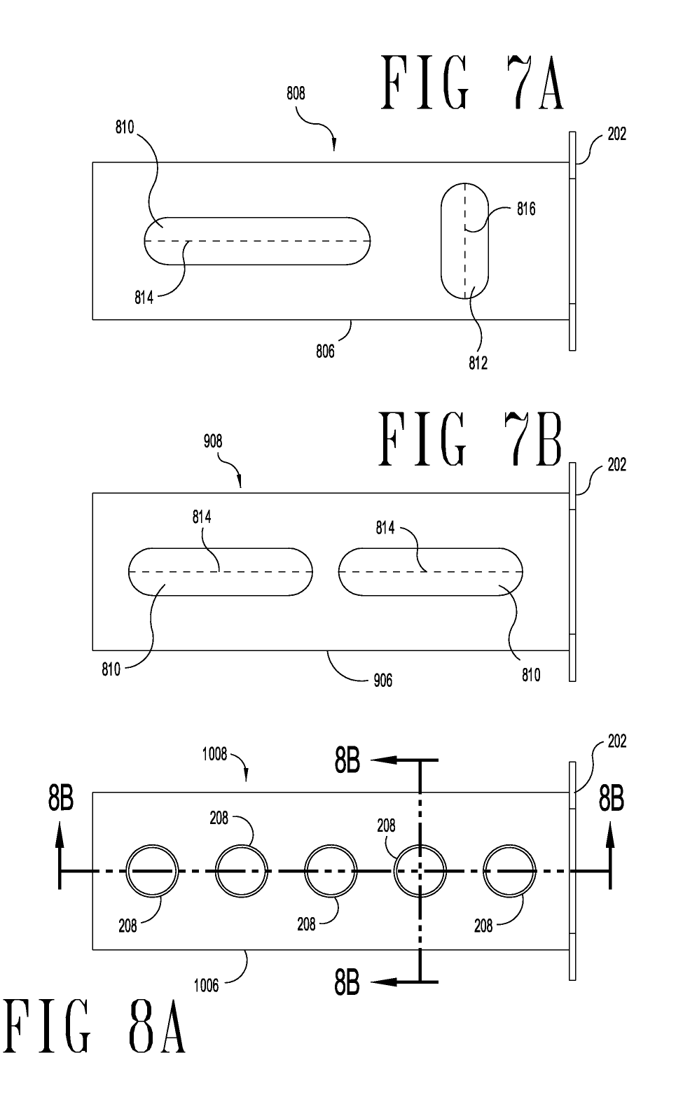

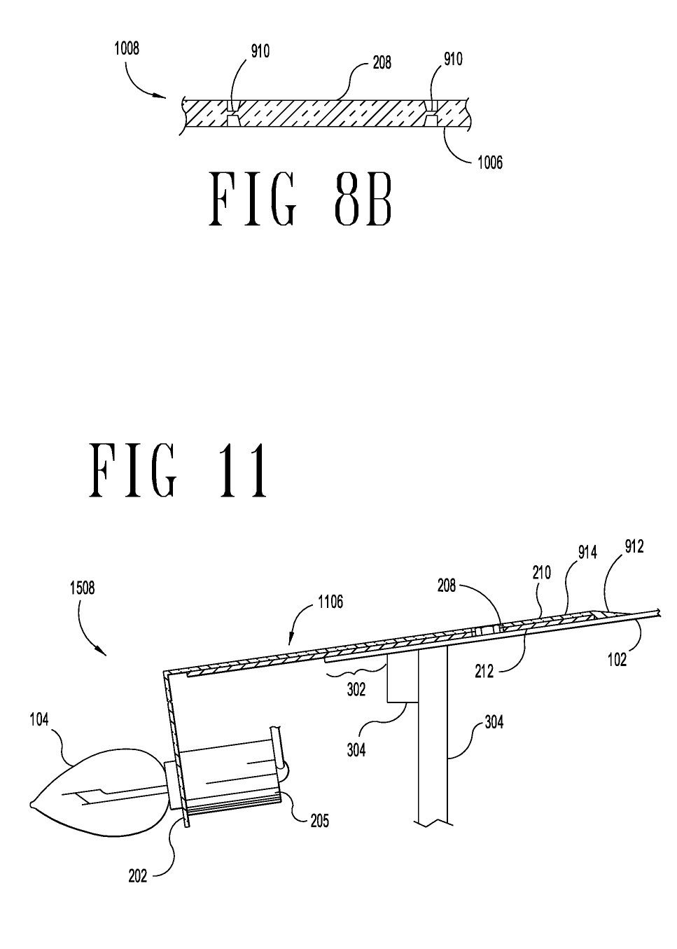

FIG. 8A shows a top view of yet still other embodiment of a decorative light mounting structure 1008. In particular, FIG. 8A illustrates that the decorative light mounting structure 1008 comprises a bulb support portion 202 and an affixation portion 1006. The affixation portion 1006 comprises a plurality of plugs 208 that are configured to “pop out” to create fastener apertures similar to the embodiments of FIG. 2 and FIG. 3. Similar to the embodiments of FIG. 3, once the plugs 208 are “popped out” to create the fastener apertures, the fastener apertures are configured to enable the use of the decorative light mounting structure 1008 in situations where a fastener previously coupled to the metallic roofing material is located where a user desires to place a decorative light mounting structure 1008. In particular, a head of the fastener (e.g., a screw head) is substantially encompassed by the fastener apertures, thereby preventing motion along the plane defined by the affixation portion 1006. In some embodiments, one or more of the fastener apertures may encompass a head of a fastener previously coupled to metallic roofing material.

FIG. 8B shows a partial cross-sectional view of decorative light mounting structure 1008 taken along the line 8B-8B of FIG. 8A. In particular, FIG. 8B illustrates the affixation portion 1006 with one of the plurality of plugs 208 of the embodiments of FIG. 8A. In at least some of the embodiments, the perimeter of the plugs 208 is comprises perforations 910. The perforations 910 enable a user to “pop out” plugs 208 from the affixation portion 1006 to create fastener aperture.

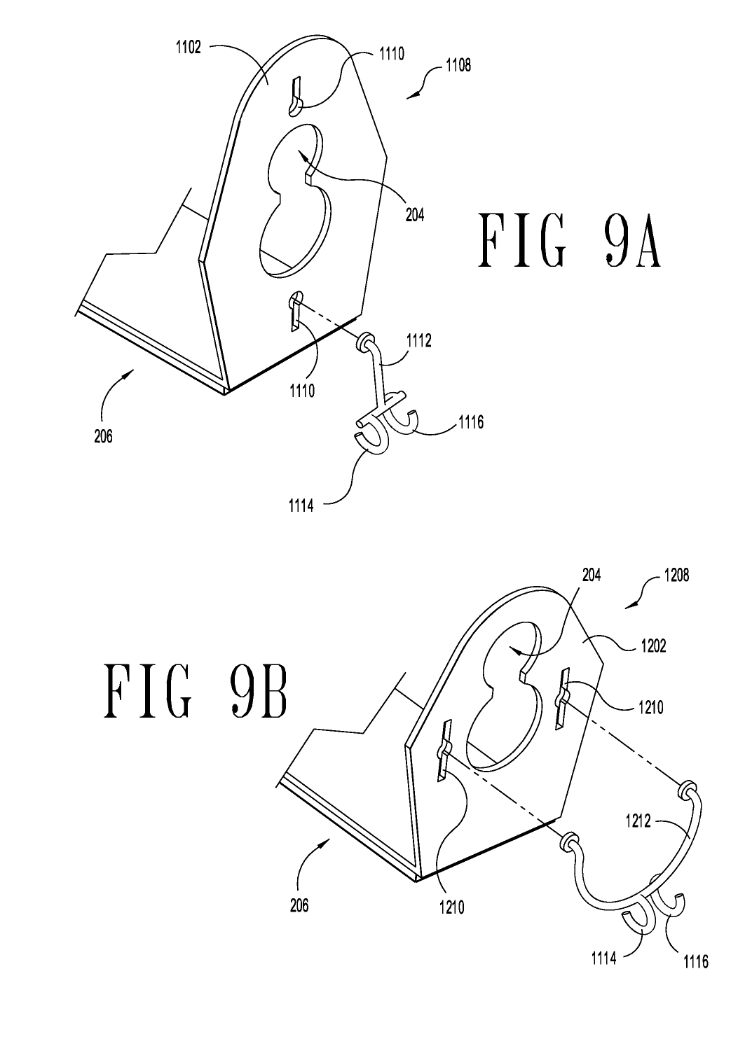

FIG. 9A shows a decorative light mounting structure 1108 in accordance with yet still other embodiments. In particular, FIG. 9A illustrates that the decorative light mounting structure 1108 comprises a bulb support portion 1102 and an affixation portion 206. Although the particular embodiment of FIG. 9A illustrates the affixation portion 206, the affixation portion may be similar to any affixation portion previously discussed. The bulb support portion 1102 is similar to the bulb support portion 202 in that it comprises a bulb aperture 204, but differs in that the bulb support portion 1102 also comprises two overhang apertures 1110. In the particular embodiment, the overhang apertures 1110 are located above and below the bulb aperture 204; however, the overhang apertures 1110 may be located at any suitable location along the bulb support portion 1108. In at least some of the embodiments, an overhanging member 1112 removably couples to the bulb support portion 1108 by extending through one of the overhang apertures 1110. In particular, the overhanging member 1112 extends through a particular overhang aperture 1110 to couple to the bulb support portion 1108 based on the orientation of the bulb support portion 1108 with respect to the sheet metal roof.

The overhanging member 1112 comprises at the distal end a hook 1114 facing towards the bulb support portion 1108, and a hook 1116 facing away from the bulb support portion 1108. In other embodiments, any number of hooks 1114-1116, and hooks facing in alternative directions, may be equivalently used. The hooks 1114-1116 engage the wiring for suspended-type decorative lights, such as lights that mimic the appearance of icicles. Thus, the decorative light mounting structure 1108 not only supports a bulb installed through the bulb apertures 204, but also enables the home owner or business owner to install suspended-type decorative lights by engaging the hooks 1114-1116.

FIG. 9B shows a decorative light mounting structure 1208 in accordance with alternative embodiments. In particular, FIG. 9B illustrates that the decorative light mounting structure 1208 comprises a bulb support portion 1202 and an affixation portion 206. The bulb support portion 1202 is similar to the bulb support portion 1102 of the embodiments of FIG. 9A in that the bulb support portion 1202 comprises two overhang apertures 1210, but differs in that the overhang apertures 1210 are located on the side of the bulb aperture 204. In at least some of the embodiments, an overhanging member 1212 removably couples to the bulb support portion 1202 by extending through both the overhang apertures 1210. The overhanging member 1212 comprises at the distal end a hook 1114 facing towards the bulb support portion 1208, and a hook 1116 facing away from the bulb support portion 1208. The hooks 1114-1116 engage wiring for suspended-type decorative lights, and enable the decorative light mounting structure 1208 to accommodate suspended-type decorative lights, such as lights that mimic the appearance of icicles.

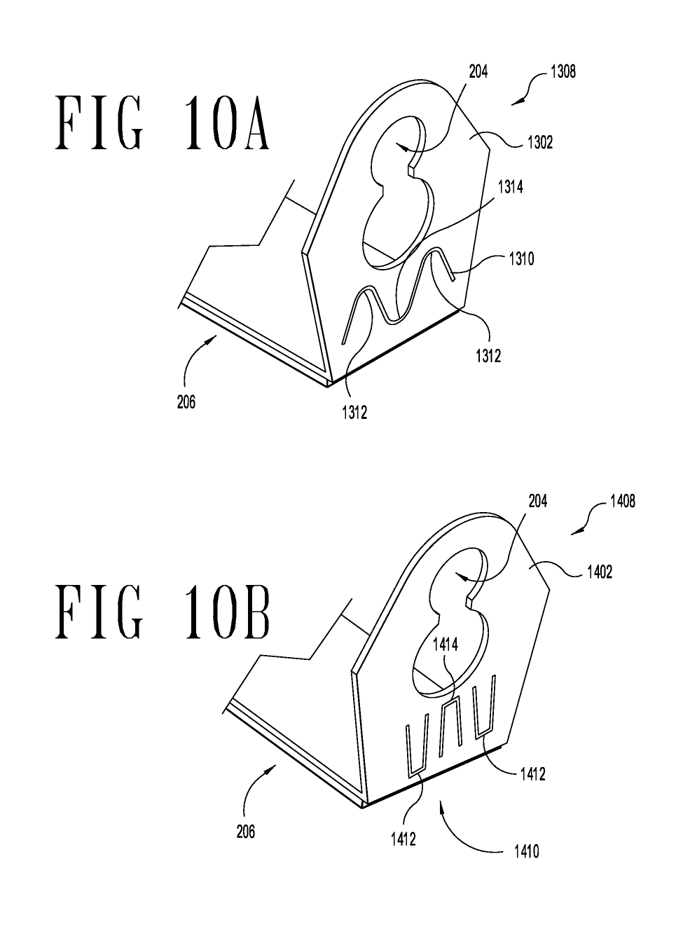

FIG. 10A shows a decorative light mounting structure 1308 in accordance with yet still other embodiments. In particular, FIG. 10A illustrates that the decorative light mounting structure 1308 comprises a bulb support portion 1302 and an affixation portion 206. The bulb support portion 1302 is similar to the bulb support portion 202 of the embodiments of FIG. 2 in that the bulb support portion 1302 comprises a bulb aperture 204, but differs in that the bulb support portion 1202 comprises a slit 1310. In at least some of the embodiments, the slit 1310 is configured to enable grips 1312 and 1314 to deflect away from the bulb support portion 1302. In the particular embodiment, the slit 1310 is configured to enable two grips 1312 that point upwards to deflect away from the bulb support portion 1302 and one grip 1314 that points downwards to deflect away from the bulb support portion 1302. In other embodiments, the slit 1310 may be configured to enable any number of grips, pointing in alternative directions, to deflect away from the bulb support portion 1302.

The grips 1312 and grip 1314 enable the decorative light mounting structure 1308 to accommodate wiring for suspended-type decorative lights, such as lights that mimic the appearance of icicles. In particular, when the grips 1312 and grip 1314 deflect away from the bulb support portion 1302 at least a portion of the wires for the suspended-type decorative lights are engaged with the grips such that the suspended-type decorative lights are suspended.

FIG. 10B shows a decorative light mounting structure 1408 in accordance with yet still other embodiments. In particular, FIG. 10B illustrates that the decorative light mounting structure 1408 comprises a bulb support portion 1402 and an affixation portion 206. The bulb support portion 1402 is similar to the bulb support portion 1302 of the embodiments of FIG. 10A in that the bulb support portion 1402 comprises a bulb aperture 204, but differs in that the bulb support portion 1402 comprises a plurality of slits 1410. In at least some of the embodiments, the slits 1410 are configured to enable two grips 1412 pointing downwards to deflect away from the bulb support portion 1402, and one grip 1414 pointing upwards to deflect away from the bulb support portion 1402. In other embodiments, any number of slits 1410 may be equivalently used. The grips 1412-1414 enable the decorative light mounting structure 1408 to accommodate wiring for suspended-type decorative lights, such as lights that mimic the appearance of icicles. In particular, at least a portion of the wires for the decorative lights are engaged with the grips 1412-1414 such that the decorative lights are suspended.

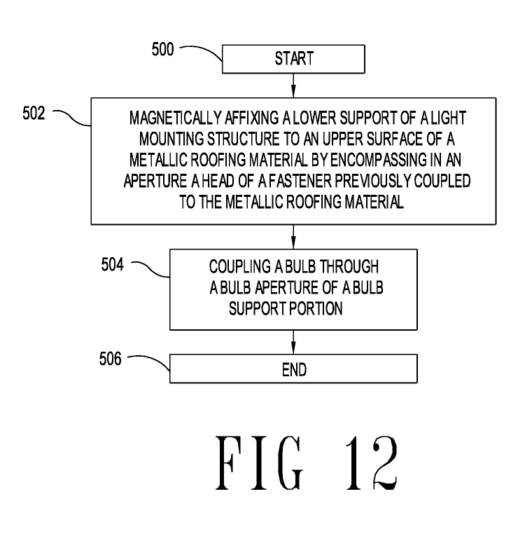

FIG. 11 shows a cross-sectional view of a decorative light mounting structure 1508 in accordance with at least some of the embodiments. In particular embodiment of FIG. 11, the metal roof 102 overhangs 302 the fascia material 304 and the decorative light mounting structure 1508 is coupled to a metal roof 102 (e.g., by at least the magnetic strip 212). The decorative light mounting structure 1508 is similar to the decorative light mounting structure 108 of the embodiments of FIG. 3 in that the bulb 104 coupled to the socket 205 through the upper portion of the bulb aperture 204, but differs in that the bulb 104 coupled to the socket 205 are below the plane defined by an affixation portion 1106. Stated otherwise, the bulb support portion 202 points downwards from sheet metal roof 102. A fastener aperture 208 is utilized to further secure the decorative light mounting structure 1508 to the sheet metal roof 102, and to reduce motion of the decorative light mounting structure 1508 in the plane defined by the affixation portion 1106. In the particular embodiment, the affixation portion 1106 also comprises an end 912 that slopes away from the top surface 914 of the affixation portion 1006. In at least some of the embodiments, the end 912 is the end opposite the bulb support portion 202. The end 912 is configured to enable materials, for example snow collected on the roof, to slide over the decorative light mounting structure 1508 when the decorative light mounting structure 1508 is affixed to a sheet metal roof. The sloped end 912 reduces the force applied by the snow to the decorative light mounting structure 1508, lowering the possibility of the decorative light mounting structure 1508 becoming dislodged by the snow.

FIG. 12 shows a method of mounting the decorative light system. In particular, the method starts (block 500) and proceeds to magnetically affixing a lower support of the decorative light mounting structure to an upper surface of a metallic roofing material encompassing in an aperture a head of a fastener previously coupled to the metallic roofing material (block 502). Thereafter, a bulb is coupled to a bulb support portion through a bulb aperture (block 504); and the method ends (block 506). Coupling may comprise inserting the bulb base through the bulb aperture and threadingly coupling the bulb base to the socket.

Various embodiments discussed to this point may be constructed of varying materials. In most situations it is envisioned that the decorative light mounting structure will be constructed of polypropylene, polystyrene, and/or any now known or after developed plastic material. In alternative embodiments, the decorative light mounting structure may be made from metal or from a magnetic material being substantially as resilient as polypropylene or polystyrene.

The above discussion is meant to be illustrative of the principles and various embodiments of the present invention. Numerous variations and modifications will become apparent to those skilled in the art once the above disclosure is fully appreciated. For example, the affixation portion itself may be magnetized, eliminating the need for a separate magnetic strip. Moreover, the decorative light mounting structure may be affixed to a non-metallic roofing material (e.g., composition shingles) without the magnetic strip 212. It is intended that the following claims be interpreted to embrace all such variations and modifications.

What is claimed is:

1. A decorative light mounting structure comprising:
a bulb support portion having an aperture; and
an affixation portion coupled to the bulb support portion, wherein the affixation portion is configured to magnetically affix the decorative light mounting structure to an upper surface of a metallic roofing material, and
an aperture in the affixation portion configured to encompass a head of a fastener coupled to the metallic roofing material prior to magnetic affixation of the affixation portion.

2. The decorative light mounting structure as defined in claim 1 wherein the affixation portion further comprises a plurality of the apertures.

3. The decorative light mounting structure as defined in claim 1 wherein the aperture is of shape selected from the group consisting of: a circle; a rectangle; an oval; and a triangle.

4. The decorative light mounting structure as defined in claim 1 wherein the affixation portion further comprises an elongated aperture.

5. The decorative light mounting structure as defined in claim 1 wherein smallest internal dimension of the aperture in the affixation portion is at least 0.5 inches.

6. The decorative light mounting structure as defined in claim 1 wherein the head of the fastener is a screw head coupled to the roofing material.

7. The decorative light mounting structure as defined in claim 1 wherein the aperture configured to encompass the head of the fastener is further configured to limit motion along a plane defined by the affixation portion.

8. The decorative light mounting structure as defined in claim 1 where the affixation portion further comprises:
a coupling layer; and
a magnetic strip coupled to the coupling layer.

9. The decorative light mounting structure as defined in claim 8 wherein the coupling layer has a thickness, measured perpendicular to a plane defined by the coupling layer, of approximately 0.125 inches.

10. The decorative light mounting structure as defined in claim 8 wherein the coupling layer substantially covers a surface of the magnetic strip.

11. The decorative light mounting structure as defined in claim 8 wherein the coupling layer couples to the magnetic strip by way of an adhesive.

12. The decorative light mounting structure as defined in claim 8 wherein the bulb support portion and the coupling layer are made from at least one material selected from the group consisting of: metal; polypropylene; and polystyrene.

13. The decorative light mounting structure as defined in claim 1 wherein the bulb support portion further comprises a plurality of fingers configured to engage suspended-type decorative lights.

14. The decorative light mounting structure as defined in claim 1 further comprises an overhanging member configured to removably couple with the bulb support portion, and the overhanging member comprises a hook configured to engage suspended-type decorative lights.

15. The decorative light mounting structure as defined in claim 14 wherein the overhanging member couples with the bulb support portion by a single overhang aperture of the bulb support portion.

16. The decorative light mounting structure as defined in claim 14 wherein the overhanging member couples with the bulb support portion by two overhang apertures of the bulb support portion.

17. The decorative light mounting structure as defined in claim 1 wherein the bulb support portion further comprises a slit configured to enable a grip deflect away from the bulb support portion, wherein the grip configured to engage suspended-type decorative lights.

18. The decorative light mounting structure as defined in claim 1 wherein the aperture of the bulb support portion is a bulb aperture having one or more diameters.

19. A system comprising:
a means for supporting a bulb and socket assembly; and
a means for magnetically affixing a decorative light mounting structure to a roofing material, the means for magnetically affixing coupled to the means for supporting;
the means for magnetically affixing further comprises a means for encompassing a head of a fastener coupled to the roofing material.

20. The system as defined in claim 19 wherein the means for encompassing is at least one elongated aperture.

21. The system as defined in claim 19 further comprising a means for engaging suspended-type decorative lights from the means for supporting.

22. The system as defined in claim 19 wherein the means for engaging further comprises a slit configured to enable a grip to deflect away from the bulb support portion.

23. A method comprising
magnetically affixing a lower support of a light mounting structure to an upper surface of a metallic roofing material by encompassing in an aperture a head of a fastener previously coupled to the metallic roofing material; and
coupling a bulb through a bulb aperture of a bulb support portion.

24. The method as defined in claim 23 wherein the head of the fastener contacts only an inside surface of the aperture.

25. The method as defined in claim 23 further comprising engaging suspended-type decorative lights by fingers of the light mounting structure.

26. The method as defined in claim 23 further comprising engaging suspended-type decorative lights by a hook of an overhanging member removably coupled to the bulb support portion.

27. The method as defined in claim 23 further comprising engaging suspended-type decorative lights by a grip deflected away from the bulb support portion.
